(19) United States
(12) Patent Application Publication
(10) Pub. No.: US 2011/0317115 A1
(43) Pub. Date: Dec. 29, 2011

(54) LIQUID CRYSTAL DISPLAY DEVICE AND METHOD FOR MANUFACTURING SAME

(75) Inventors: Manabu Abiru, Osaka (JP); Shinji Yamagishi, Osaka (JP)

(73) Assignee: SHARP KABUSHIKI KAISHA, Osaka (JP)

(21) Appl. No.: 13/148,620

(22) PCT Filed: Oct. 13, 2009
(86) PCT No.: PCT/JP2009/005327

§ 371 Date: Aug. 9, 2011

(30) Foreign Application Priority Data
Feb. 23, 2009 (JP) 2009-039668

(51) Int. Cl. G02F 1/1337; H01J 9/24

(52) U.S. Cl. 349/123; 445/24

(57) ABSTRACT

A liquid crystal display device is configured such that the liquid crystal display device detects a pressed position by having contact regions, which are a part of the first substrate and a part of the second substrate, in contact with each other when the first substrate or the second substrate is bent by being pressed and in each of the contact region of the first substrate and the second substrate, a conductive film that repels an alignment film before hardening is arranged such that the conductive film is exposed from the hardened alignment film.

### TECHNICAL FIELD

This invention relates to a liquid crystal display device which detects positional information on a display screen and a method for manufacturing the same.

### BACKGROUND ART

In recent years, a liquid crystal display device has been widely used for various devices such as personal computers, mobile phones, PDAs and gaming systems. Additionally, a liquid crystal display device detecting positional information on a display screen by having a touch panel placed over a liquid crystal display panel is also known. As for a position detection method of a touch panel, the resistive type and the electrostatic capacitance type and the like, for example, are generally known.

In the resistive type, both a surface of a substrate bonded to a display panel and a surface on the substrate side of a film bonded over the surface of the substrate with a narrow gap have transparent conductive films bonded thereon. When the film is pressed by a finger or the tip of a pen and the like, the film is bent toward the substrate side, having the respective transparent conductive films make contact with each other and thereby they become electrically connected. At this time, by reading respective voltage division of electrical potential in each of the transparent conductive film, the pressed position is detected.

However, the configuration of placing a touch panel over a display panel has a problem of the reduction of display contrast due to reflected light generated from the surface of the display panel, the back surface of the touch panel, inside of the touch panel and from the surface of the touch panel.

Additionally, the loss of the display visual quality as a result of moire produced by the respective reflected light interfering with each other is also a problem. Further, the structure of laminating a display panel and a touch panel causes another problem of an increase in the thickness of the entire display device.

In this connection, a liquid crystal display device having a so-called in-cell touch panel which integrates a liquid crystal display panel and a resistive type touch panel has been disclosed. (See Patent Documents 1 and 2 and the like, for example)

Disclosed in Patent Document 1 is placing a first touch electrode over gate wiring and source wiring of TFT substrate which constitute a liquid crystal display panel, while placing a second touch electrode over black matrix of an opposite substrate to form the first and second touch electrodes in a grid pattern. Also, it discloses not providing an alignment film on a surface where first and second touch electrodes are in contact with each other such that the first touch electrode and the second touch electrode are not insulated by an alignment film and electrical conduction therebetween is ensured.

Disclosed in Patent Document 2 is applying an organic solvent (γ-Butyrolactone) to an alignment film covering a touch electrode by using the inkjet method to dissolve the alignment film locally and therefore exposing the touch electrode from the alignment film.

### RELATED ART DOCUMENTS

### Patent Documents

Patent Document 1: Japanese Patent Application Laid-Open Publication No. 2001-075074

Patent Document 2: Japanese Patent Application Laid-Open Publication No. 2007-052369

### SUMMARY OF THE INVENTION

### Problems to be Resolved by the Invention

However, the shortest pitch of the position where an organic solvent is applied by the inkjet method is in the range of about 70 μm and relatively large, therefore, if a touch electrode measuring about 20 μm×20 μm, for example, is formed, it is difficult to remove an alignment film with accuracy and reliably expose touch electrodes using the inkjet method. That is to say, there is a problem with the method described in Patent Document 2 in that it is difficult to remove the alignment film from a micro-sized touch electrode with accuracy.

This invention was made in view of such a consideration and it is an object of the present invention to remove an alignment film with accuracy in a region where a pair of substrates make contact with each other.

### Means for Solving the Problems

To achieve the above-described object, a liquid crystal display device according to the present invention includes a first substrate, a second substrate placed opposite to the first substrate, a liquid crystal layer disposed between the first substrate and the second substrate, and an alignment film provided and hardened on the surfaces on the liquid crystal layer side of the first substrate and the second substrate, respectively, the liquid crystal display device being configured such that the liquid crystal display device detects a pressed position by having contact regions, which are a part of the first substrate and a part of the second substrate, in contact with each other when the first substrate or the second substrate is bent by being pressed, wherein, in each of the contact regions of the first substrate and the second substrate, a conductive film, which repels the alignment film before hardening, is arranged respectively such that the conductive film in exposed from the hardened alignment film.

Additionally, in the contact region of the first substrate, a touch sensor projection projecting toward the second substrate side may be formed, and the conductive films may be configured to include a first conductive film provided in the tip side of the touch sensor projection and a second conductive film provided in the contact region of the second substrate.

Further, at the end of the touch sensor projection, a first electrode covered with the first conductive film may be provided, and on the other hand, in the contact region of the second substrate, a second electrode covered with the second conductive film may be provided.

Furthermore, in the second substrate, a detection element which is connected to the second electrode and detects conduction state between the second electrode and the first electrode may be arranged.

Additionally, a manufacturing method of a liquid crystal display device according to this present invention is a method of manufacturing a liquid crystal display device including a first substrate and a second substrate placed opposite to each other having a liquid crystal layer therebewteen, and alignment films arranged and hardened on respective surfaces on the liquid crystal layer side of the first substrate and the second substrate, and is configured so as to detect a pressed position by having contact regions, which are a part of the first substrate and a part of the second substrate, in contact with each other when the first substrate or the second substrate is bent by being pressed, and the manufacturing method includes a first step where the first substrate is formed by forming a first conductive film which repels the alignment film before hardening in a region which becomes a contact region of the first substrate in a first insulating substrate, and then applying the alignment film before hardening to the first insulating substrate to expose the first conductive film from the alignment film; a second step where the second substrate is formed by forming a second conductive film which repels the alignment film before hardening in a region which becomes a contact region of the second substrate in a second insulating substrate, and then applying the alignment film before hardening to the second insulating substrate to expose the second conductive film from the alignment film; and a third step where the first substrate and the second substrate are bonded together on the sides where alignment films are formed.

In the first step, after a touch sensor projection projecting toward the second substrate side is formed in a region which becomes a contact region of the first substrate in the first insulating substrate, the first conductive film may be formed in the tip side of the touch sensor projection.

Additionally, in the first step, after a first electrode is formed at the end of the touch sensor projection, the first conductive film may be formed so as to cover the first electrode, and in the second step, after a second electrode is formed in the region which becomes the contact region of the second insulating substrate, the second conductive film may be formed so as to cover the second electrode.

Further, in the second step, a detection element which is connected to the second electrode and detects conduction state between the second electrode and the first electrode may be formed in the second insulating substrate.

Furthermore, in the first step and the second step, it is preferable to form the first conductive film and the second conductive film, respectively, using photolithography.

Features

Features of the present invention are described hereinafter.

In the liquid crystal display device, when the first substrate or the second substrate is bent by being pressed, a contact region of the first substrate and a contact region of the second substrate make contact with each other. Since conductive films are provided in each contact region of the first substrate and the second substrate such that the conductive films are exposed from an alignment film, when the first substrate or the second substrate is pressed, the conductive films of each contact region make contact with each other and become electrically connected. The pressed position is thereby detected.

Additionally, in a case where a touch sensor projection is formed in a contact region of the first substrate, when the first substrate or the second substrate is pressed, a first conductive film provided on the tip side of the touch sensor projection makes contact with a second conductive film provided in a contact region of the second substrate, having them electrically connected.

Further, in a case where the first conductive film is formed so as to cover the first electrode, and also, the second conductive film is formed so as to cover the second electrode, the first electrode and the second electrode will be electrically connected through the first conductive film and the second conductive film.

Furthermore, in a case where a detection element connected to the second electrode is arranged in the second substrate, conduction state between the first electrode and the second electrode can be detected by the detection element.

In manufacturing the liquid crystal display device, in the first step, the first conductive film, which repels an alignment film before hardening, is first formed in a region which becomes a contact region of the first substrate in the first insulating substrate. Thereafter, by applying an alignment film before hardening to the first insulating substrate to expose the first conductive film from this alignment film, the first substrate is formed. The first conductive film can be formed more accurately using the photolithography method, for example.

In this first step, after forming the touch sensor projection projecting toward the second substrate side in a region which becomes a contact region of the first substrate in the first insulating substrate, the first conductive film may be formed at the tip side of this touch sensor projection. This makes it possible to detect a pressed position more accurately.

Further, after a first electrode is preformed in the touch sensor projection, if the first conductive film is formed so as to cover the first electrode, the reliable position detection at the tip side of the touch sensor projection is made possible by these first electrode and first conductive film.

Thereafter, an alignment film before hardening is applied to the first insulating substrate. At this time, since the alignment film is repelled by the first conductive film in the region which becomes the contact region, the first conductive film is exposed from the alignment film. In this manner, the first substrate is formed.

Meanwhile, in the second step, the second conductive film, which repels an alignment film before hardening, is first formed in a region which becomes a contact region of the second substrate in the second insulating substrate. Thereafter, by applying the alignment film before hardening to the second insulating substrate to expose the second conductive film from this alignment film, the second substrate is formed. Similar to the first conductive film, the second conductive film can be formed more accurately using the photolithography method, for example.

Further, after the second electrode is preformed in a region which becomes a contact region of the second substrate, the second conductive film may be formed so as to cover the second electrode. By these second electrode and second conductive film, the reliable position detection in the contact region of the second substrate is made possible.

Further, in this case, a detection element may be formed in the second insulating substrate and connected to the second electrode. This makes it possible to detect conduction state between the first electrode and the second electrode by the detection element.

Thereafter, an alignment film before hardening is applied to the second insulating substrate. At this time, since the alignment film is repelled by the second conductive film in the region which becomes the contact region, the second conductive film is exposed from the alignment film. In this manner, the second substrate is formed.

Next, in the third step, the first substrate and the second substrate are bonded together, on a side of the first substrate where the alignment film is formed and a side of the second substrate where the alignment film is formed. In this manner, the liquid crystal display device is manufactured.

### Effects of the Invention

According to the present invention, since a conductive film that repels an alignment film before hardening is provided in each contact region of the first substrate and the second substrate respectively, even in a case where the contact region is relatively small, the alignment film can be removed from the contact region with accuracy. As a result, a pressed position in a liquid crystal display device can be detected with a high degree of accuracy.

### BRIEF DESCRIPTION OF THE DRAWINGS

FIG. 1 is a schematic cross-sectional view showing a vertical cross-sectional structure of a liquid crystal display device according to an embodiment of the present invention.

FIG. 2 is a schematic plan view showing a plurality of pixels of a liquid crystal display device according to an embodiment of the present invention.

FIG. 3 is an enlarged plan view of one pixel in a TFT substrate.

FIG. 4 is a cross-sectional view along the line IV-IV in FIG. 3.

FIG. 5 is a circuit diagram showing a circuit configuration including TFTs and a detection element.

FIG. 6 is a cross-sectional view showing a conductive film 49 formed on a glass substrate 35.

FIG. 7 is a cross-sectional view showing a second conductive film 39 formed by photolithography.

FIG. 8 is a cross-sectional view showing a second alignment film formed on a glass substrate 35.

### DETAILED DESCRIPTION OF EMBODIMENTS

Hereinafter, embodiments of the present invention are described in detail with reference to the figures, but the present invention is not limited to such embodiments.

### EMBODIMENTS OF THE INVENTION

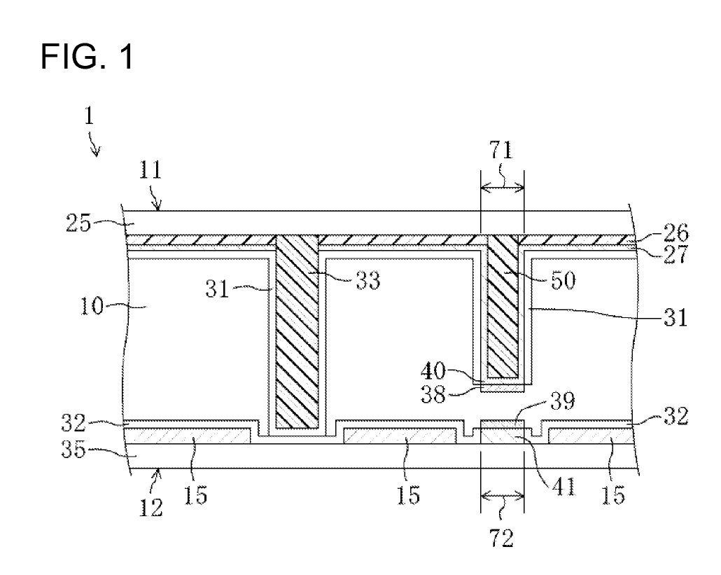

FIGS. 1 to 7 show embodiments of the present invention.

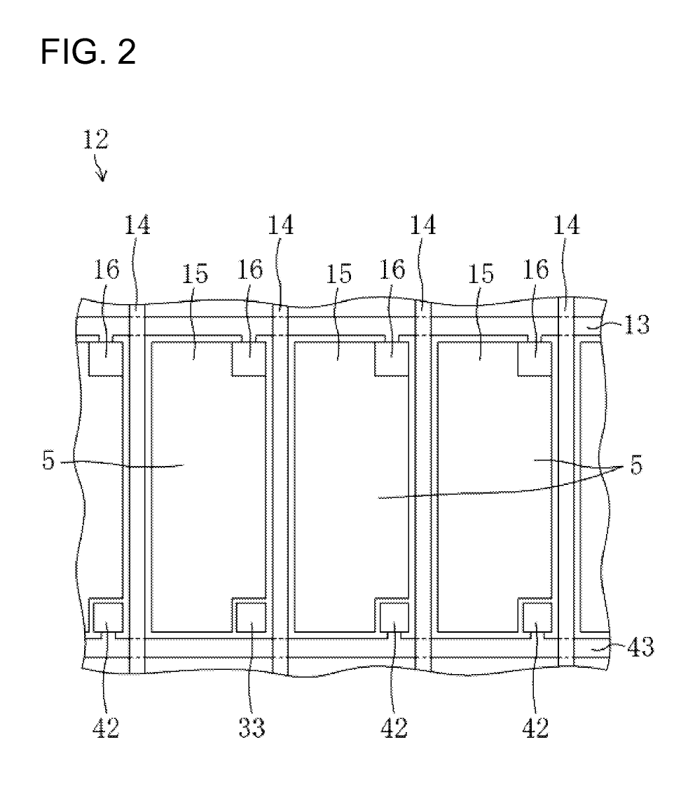

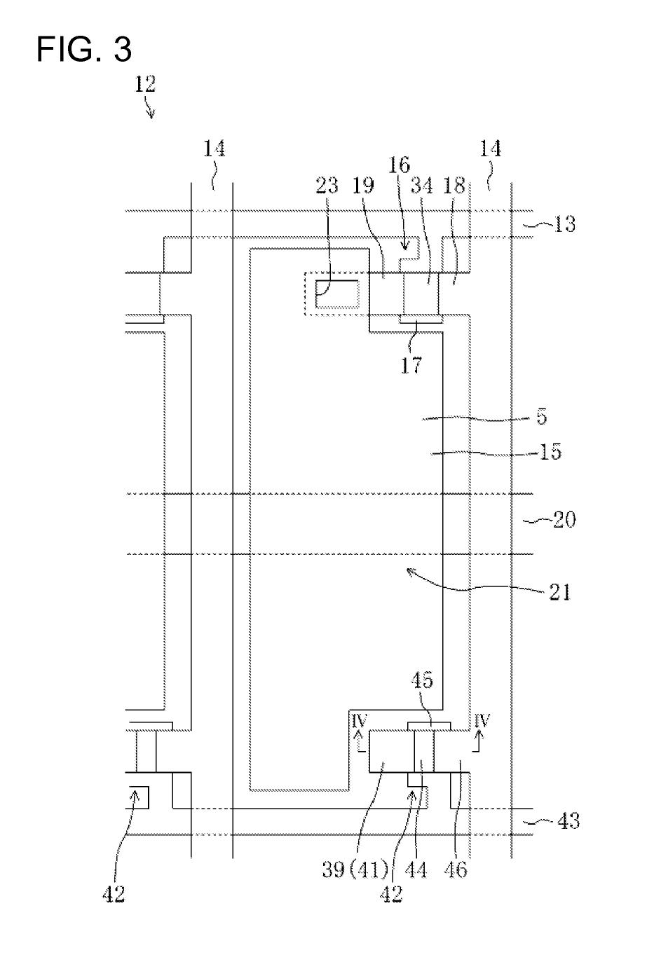

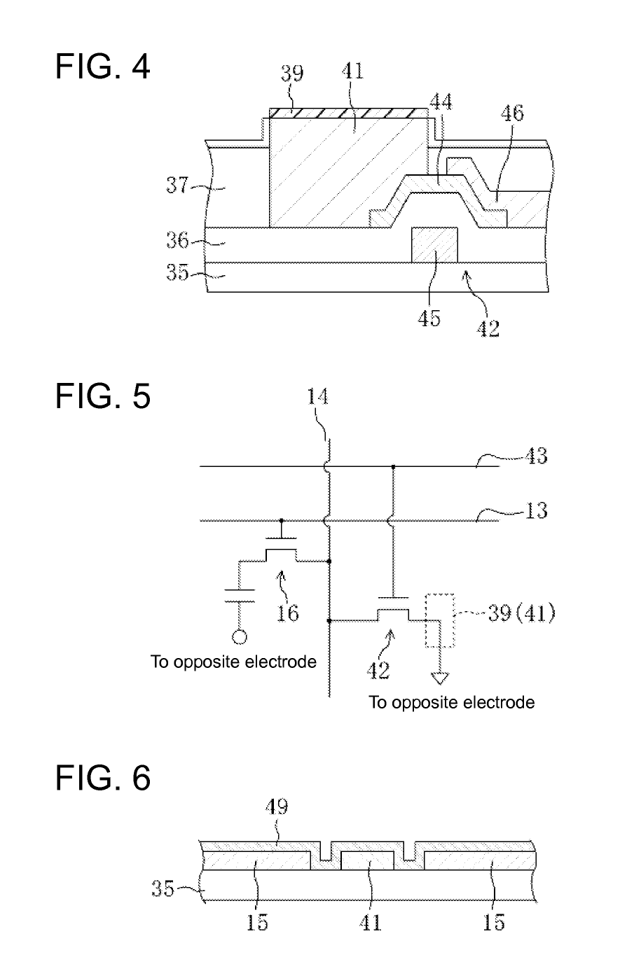

FIG. 1 is a schematic cross-sectional view showing a vertical cross-sectional structure of a liquid crystal display device 1 of an embodiment of the present invention. FIG. 2 is a schematic plan view showing a plurality of pixels 5 of the liquid crystal display device 1 of an embodiment of the present invention. FIG. 3 is an enlarged plan view showing one pixel 5 in TFT substrate 12. FIG. 4 is a cross-sectional view along the line IV-IV in FIG. 3. FIG. 5 is a circuit diagram showing a circuit configuration including TFT 16 and a detection element 42.

Configuration of Liquid Crystal Display Device

The liquid crystal display device 1 of an embodiment of the present invention is configured, at least, in a transmissive liquid crystal display device capable of transparent display, for example. As shown in FIG. 1, the liquid crystal display device 1 includes: an opposite substrate 11, which is a first substrate; a TFT substrate 12, which is a second substrate placed opposite to the opposite substrate 11; a liquid crystal layer 10 provided between the opposite substrate 11 and the TFT substrate 12; and alignment films 31 and 32 provided and hardened on the respective surfaces on the crystal layer 10 side of the opposite substrate 11 and TFT substrate 12.

As shown in FIG. 1, the liquid crystal display device 1 has a so-called in-cell type touch panel and is configured such that when the opposite substrate 11 or the TFT substrate 12 is bent by being pressed, the pressed position (touch position) is detected by having contact regions 71 and 72, i.e., a part of the opposite substrate 11 and a part of the TFT substrate 12, in contact with each other.

Although not shown in the figure, the liquid crystal display device 1 has a display region which is rectangular in shape, for example, and a frame region which is a non-display region formed around the display region in a frame-like shape. The display region is constituted by a plurality of pixels 5 arranged in a matrix.

(Configuration of Opposite Substrate)

As shown in FIG. 1, the opposite substrate 11 includes a glass substrate 25 as a first insulating substrate, and color filter layer 26 and opposite electrode (common electrode) 27, which are laminated in that order on the liquid crystal layer 10 side of the glass substrate 25.

The glass substrate 25 is formed in the thickness of 0.7 mm or less, for example, and a not shown polarizing plate is bonded on the opposite side surface of the glass substrate 25 to the liquid crystal layer 10.

The color filter layer 26 is constituted by a colored layer of a plurality of colors. The colored layer is constituted by each colored layer of red (R), green (G), and blue (B). Although not shown in the figure, between respective adjacent colored layers, black matrix, i.e., a light shielding film is formed.

The opposite electrode 27 is made of ITO (Indium Tin Oxide), for example, and formed across the entire display region almost uniformly so as to cover the color filter layer 26 and the black matrix.

Additionally, in the opposite substrate 11, as shown in FIG. 1, a spacer 33 defining a thickness of the liquid crystal layer 10 is formed, projecting toward the TFT substrate 12 side. The spacer 33 is a so-called photo spacer and is formed by the same material as that of the colored layer of the color filter layer 26, for example, and as shown in FIG. 2, placed in the right bottom corner area in the pixel 5, for example.

On the surface on the liquid crystal layer 10 side of the opposite substrate 11, a first alignment film 31 made of polyimide and the like, for example, is formed. The first alignment film 31 is arranged so as to cover the opposite electrode 27 and a surface of the spacer 33. And, the spacer 33 has the end thereof in contact with a surface of the TFT substrate 12 through the first alignment film 31.

(Configuration of TFT Substrate)

Meanwhile, the TFT substrate 12 is configured as a so-called active matrix substrate. The TFT substrate 12 includes a glass substrate 35 as a second insulating substrate. The glass substrate 35 is formed in the thickness of 0.7 mm or less, for example.

As shown in FIGS. 2 and 3, on the glass substrate 35, a plurality of gate wiring 13 are formed extending parallel to each other. Also, on the TFT substrate 12, a plurality of source wiring 14 are formed so as to extend, crossing the gate wiring. Therefore, on the TFT substrate 12, the wiring constituted by the gate wiring 13 and the source wiring 14 is formed in a grid pattern.

As shown in FIGS. 2 and 3, each pixel 5 is formed by a rectangular shaped region divided by the gate wiring 13 and the source wiring 14. In each pixel 5, a plurality of pixel electrodes 15 placed oppose to the opposite electrode 27, and TFT (Thin-Film Transistor) 16, which is a switching element connected to the pixel electrode 15 and used as a switching-driver of the liquid crystal layer 10, are formed.

The TFT 16 is arranged in the right top corner area in FIGS. 2 and 3 in the pixel 5, for example, and has a gate electrode 17 connected to the gate wiring 13, a source electrode 18 connected to the source wiring 14, and a drain electrode 19 connected to the pixel electrode 15. In other words, the gate wiring 13 and the source wiring 14 are connected to the TFT 16. Also, semiconductor layer 34 is disposed between the gate electrode 17, and the source electrode 18 and the drain electrode 19.

The drain electrode 19 is covered with an interlayer insulating film (not shown in the figure), and as shown in FIG. 3, a contact hole 23 is formed through the interlayer insulating film. The drain electrode 19 is connected to the pixel electrode 15 through the contact hole 23. As shown in FIG. 1, the pixel electrode 15 is covered with a second alignment film 32.

In this manner, with scanning voltage applied to the gate electrode 17 through the gate wiring 13, signal voltage will be supplied from the source wiring 14 to the pixel electrode 15 through the source electrode 18 and the drain electrode 19. As a result, by the signal voltage applied between the pixel electrode 15 and the opposite electrode 27, the liquid crystal layer 10 of the pixel 5 will be driven, and thereby, a desired image will be displayed.

Additionally, in the TFT substrate 12, as shown in the FIG. 3, a plurality of capacitance wiring 20 is formed parallel to each other along the gate wiring 13 such that they run through the almost center of each pixel 5. Between the capacitance wiring 20 and the pixel electrode 15, a not shown insulating film is disposed and by them, a capacitance element 21, which may also be referred to as auxiliary capacitance, is formed. The capacitance element 21 is formed in each pixel 5, respectively, and is configured to maintain display voltage in each pixel 5 to be almost constant.

On the surface on the liquid crystal layer 10 side of the TFT substrate 12, the second alignment film 32 made of polyimide and the like, for example, is formed. The second alignment film 32 is arranged on the glass substrate 35 so as to cover the surface of the pixel electrode 15.

(Configuration of Contact Region)

As a feature of the present invention, as shown in FIG. 1, in a first contact region 71, which is a contact region of the opposite substrate 11, and in a second contact region 72, which is a contact region of the TFT substrate 12 opposite thereto, conductive films 38 and 39 which repel alignment films 31 and 32 before hardening are arranged, respectively, such that the conductive films are exposed from the hardened alignment films 31 and 32.

That is, in the first contact region 71 of the opposite substrate 11, a touch sensor projection 50, projecting toward the TFT substrate 12 side, is formed. Similar to the spacer 33, the touch sensor projection 50 is formed by the same material as that of the colored layer of the color filter layer 26, but the projection length is shorter than that of the spacer 33. These touch sensor projections 50 are arranged in the right bottom corner area in the pixel 5, for example, similar to the spacer 33.

The conductive films 38 and 39 include a first conductive film 38 provided in the tip side of the touch sensor projection 50 and a second conductive film 39 provided in the second contact region 72 of the TFT substrate 12, which will be explained later. The first conductive film 38 and the second conductive film 39 have a configuration in which conductive particulates, such as tin oxide and indium oxide, for example, dispersed in a water repellent material such as silicon rubber and fluorinated resin, for example.

Also, at the tip of the touch sensor projection 50, a first electrode 40 is provided. Here, as shown in the FIG. 1, the touch sensor projection 50, together with the color filter layer 26, is covered with the opposite electrode 27, and the portion of the opposite electrode 27 covering the tip of the touch sensor projection 50 constitutes the first electrode 40. The first electrode 40 is covered with the first conductive film 38.

As shown in FIG. 1, the first alignment film 31 is provided so as to cover the opposite electrode 27 covering the color filter layer 26 and the opposite electrode 27 covering the side faces of the touch sensor projection 50, and to cover the side faces and the end of the spacer 33 respectively. That is to say, in the tip side of the touch sensor projection 50 in the first contact region 71, the first alignment film 31 is not provided and the first conductive film 38 is exposed.

Meanwhile, in the second contact region 72 of the TFT substrate 12, a second electrode 41 as a touch electrode is formed on the glass substrate 35. In each pixel 5, the second electrode 41 is arranged in a notched portion of the pixel electrode 15 in the right bottom corner area, for example, of FIG. 3, and is formed such that the surface thereof is on the same level as the pixel electrode 15. Also, the second electrode 41 is made of ITO, for example, and formed in the same step as the pixel electrode 15.

Additionally, as shown in FIG. 1, the surface on the touch sensor projection 50 side of the second electrode 41 is covered with the second conductive film 39. Meanwhile, the side faces of the second electrode 41 are, as shown in the FIG. 1, covered with the second alignment film 32. That is to say, the second alignment film 32 is not provided in the second contact region 72 and the second conductive film 39 is exposed. Therefore, the second conductive film 39 faces the first conductive film 38. When the opposite substrate 11 is pressed and bent toward the TFT substrate 12 side, for example, the second conductive film 39 makes contact with the first conductive film 38, and the second electrode 41 is thereby electrically connected to the first electrode 40 through the second conductive film 39 and the first conductive film 38.

(Detection Element)

Additionally, as shown in FIGS. 2 to 4, in the TFT substrate 12, in each pixel 5, a detection element 42 connected to the second electrode 41 is formed. The detection element 42 is used to detect conduction state between the second electrode 41 and the first electrode 40 (i.e., the opposite electrode 27).

The detection element 42 is arranged in the right bottom corner area, for example, of FIGS. 2 and 3 in each pixel 5 and is constituted by a TFT. As shown in FIGS. 3 and 5, detection wiring 43 extending along the gate wiring 13 and the source wiring 14 are connected to the detection element 42.

That is to say, the detection element 42 includes a gate portion 45 connected to the detection wiring 43, the source portion 46 connected to the source wiring 14, and the drain portion, i.e., the second electrode 41. As shown in FIG. 4, on the glass substrate 35, a gate insulating film 36 is formed so as to cover the gate portion 45. On the surface of the gate insulating film 36, a semiconductor layer 44 is formed so as to cover the gate position 45. Further, to cover portions of the surface of the semiconductor layer 44, the source portion 46 and the second electrode 41 are formed. While the source portion 46 is covered with the interlayer insulating film 37, the second electrode 41 is not covered with the interlayer insulating film 37, and the second conductive film 39 is laminated thereon.

Touch Position Detection Method

Hereinafter, a touch position detection method by the liquid crystal display device 1 is explained.

When prescribed scanning voltage is applied to the detection wiring 43 of a certain row, the second electrode 41, which is the drain portion of the detection element 42 connected to the detection wiring 43, and the source portion 46 are electrically connected, creating the ON state. At this time, if the opposite substrate 11 is being touched by a user and the first conductive film 38 in the tip side of the touch sensor projection 50 in the opposite substrate 11 is in contact with the second electrode 41 in the detection element 42, which is in the ON state, the second electrode 41 is electrically connected to the first electrode 40 through the second conductive film 39 and the first conductive film 38, and thereby current is made to flow to the source wiring 14 in accordance with the voltage applied to the opposite electrode 27. By this current being detected, a touch position (pressed position) is detected.

Meanwhile, if the opposite substrate 11 is not touched, and the first conductive film 38 and the second conductive film 39 are not in contact with each other, current is not made to flow to the source wiring 14. Therefore, in this case, a touch position (pressed position) is not detected and it is detected to be non-contact. By performing this sequence of position detections row by row sequentially, the touch position detection for the entire display region is performed.

Manufacturing Method

Hereinafter, a method of manufacturing the liquid crystal display device 1 is described with references to FIGS. 6 to 8.

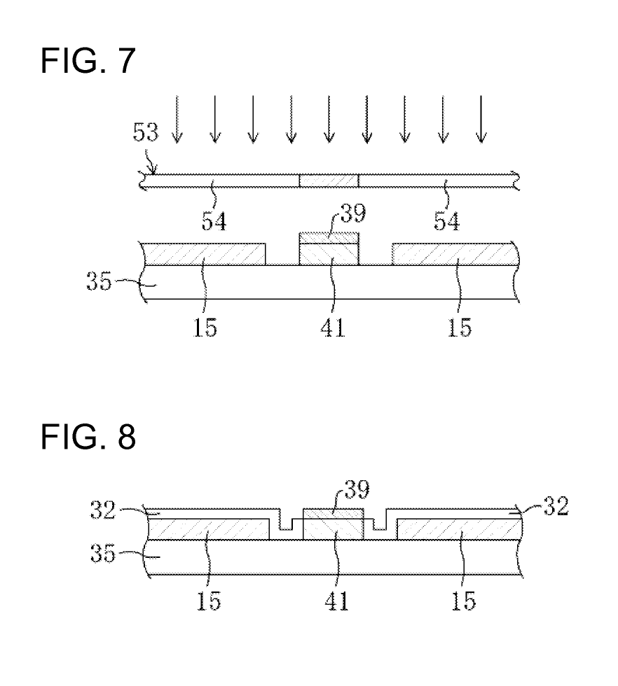

FIG. 6 is a cross-sectional view showing a conductive film 49 formed on the glass substrate 35. FIG. 7 is a cross-sectional view showing the second conductive film 39 formed by photolithography. FIG. 8 is a cross-sectional view showing a second alignment film formed on the glass substrate 35.

A manufacturing method according to an embodiment of the present invention includes a first step to form the opposite substrate 11; a second step to form the TFT substrate, and a third step to bond the opposite substrate 11 and the TFT substrate 12 each other. Either of the first step or the second step may take place first.

(Second Step)

For convenience of description, the second step is explained first. In this second step, first, the pixel electrode 15, the second electrode 41, the TFT 16, the detection element 42 and the like are formed on the glass substrate 35 by photolithography. The second electrode 41 is formed in a region that becomes the second contact region 72 on the glass substrate 35 and is formed simultaneously with the pixel electrode 15 in the same step. Also, the detection element 42 is formed simultaneously with TFT16 in the same step.

Further, as shown in FIG. 6, the conductive film 49 is applied and formed on the entire surface of the glass substrate 35 so as to cover the second electrode 41 and the pixel electrode 15 and the like. The conductive film 49 has a configuration of conductive particulates, such as tin oxide and indium oxide, for example, dispersed in a water repellent material such as silicon rubber and fluorinated resin, for example.

Next, as shown in FIG. 7, a photomask 53 having an opening 54 is placed opposite to the glass substrate 35 and is positioned such that a region on the second electrode 41 (i.e., a region that becomes the second contact region 72 on the glass substrate 35) is shielded from light. Then, the conductive film 49 is radiated with ultraviolet light through this mask 53 in an ozone atmosphere.

This causes the conductive film 49 formed in regions other than the region on the second electrode 41 to be removed due to ashing by the photolithography, and as a result, in the region that becomes the second contact region 72, the second conductive film 39 is formed to cover the second electrode 41.

Thereafter, a second alignment film 32 before hardening in the form of liquid is applied to the glass substrate 35. Since the second conductive film 39 has a property which repels the second alignment film 32 made of polyimide and the like, the second alignment film 32 is repelled and removed from the surface of the second conductive film 39. The second conductive film 39 is thereby exposed from the second alignment film 32. In this manner, the TFT substrate 12 is formed.

(First Step)

Meanwhile, in the first step, first, the color filter layer 26 and black matrix (not shown in the figure) are formed on the glass substrate 25 by photolithography, and also, the spacer 33 and the touch sensor projection 50 are formed as well. The spacer 33 and the touch sensor projection 50 are formed in the same step as the color filter layer 26. Also, the touch sensor projection 50 is formed in a region which becomes the first contact region 71 in the glass substrate 25.

Subsequently, on the surface of the color filter layer 26 and the surface of the touch sensor projection 50, an ITO film is deposited to form the opposite electrode 27. The first electrode 40 is formed by the opposite electrode 27 formed at the tip of the touch sensor projection 50.

Next, a first conductive film 38 is formed in a region which becomes the first contact region 71 (i.e., the tip side of the touch sensor projection 50) in the glass substrate 25. The first conductive film 38 is formed by photolithography, similar to the above-described second conductive film 39.

That is, although not shown in the figure, on the entire surface of the glass substrate 25, a conductive film (not shown) made of the same material as that of the conductive film 49 is applied and formed so as to cover the opposite electrode 27 including the first electrode 40 and the spacer 33 and the like. Next, the conductive film is irradiated with ultraviolet light through a photomask (not shown) in an ozone atmosphere. This causes the conductive film formed in regions other than the region on the first electrode 40 to be removed due to ashing by photolithography, and as a result, the first conductive film 38 is formed on the tip side of the touch sensor projection 50 in the region which becomes the first contact region 71 so as to cover the first electrode 40.

Thereafter, a first alignment film 31 before hardening in the form of liquid is applied to the glass substrate 25. Since the first conductive film 38 has a property which repels the first alignment film 31 made of polyimide and the like, the first alignment film 31 is repelled and removed from the surface of the first conductive film 38. The first conductive film 38 is thereby exposed from the first alignment film 31. In this manner, the opposite substrate 11 is formed.

(Third Step)

Thereafter, a third step is performed to bond one side of the opposite substrate 11 where the first alignment film 31 is formed and one side of the TFT substrate 12 where the second alignment film 32 is formed together and to fill a liquid crystal layer 10 between these TFT substrate 12 and opposite substrate 11. In this manner, the liquid crystal display device 1 is manufactured.

Effects of Embodiment 1

Therefore, according to Embodiment 1, because the first conductive film 38 which repels the first alignment film 31 before hardening is formed in the first contact region 71 of the opposite substrate 11 by photolithography and because the second conductive film 39 which repels the second alignment film 32 before hardening is formed in the second contact region 72 of the TFT substrate 12 by photolithography, even if the first and the second contact regions 71 and 72 are relatively small, the first alignment film 31 can be removed from the first contact region 71 with accuracy and also the second alignment film 32 can be removed from the second contact region 72 with accuracy. As a result, at a touch position (pressed position), electrical conduction between the first electrode 40 and the second electrode 41 through the first conductive film 38 and the second conductive film 39 is ensured, and therefore, a touch position (pressed position) in the liquid crystal display device 1 can be detected with a high degree of accuracy.

Additionally, because the second electrode 41 which makes contact with the opposite electrode 27 when the opposite substrate 11 is pressed, and the detection element 42 which detects conduction between the second electrode 41 and the opposite electrode 27 are arranged in a plurality of the pixels 5, multiple touch points can be detected at the same time.

Furthermore, because one of the detection wiring connected to the detection element 42 is commonly used for source wiring 14, the number of wiring can be reduced and the aperture ratio of the pixel 5 can be improved.

### OTHER EMBODIMENTS

In the above embodiment, the configuration of laminating the first conductive film 38 on the first electrode 40 and laminating the second conductive film 39 on the second electrode 41 has been described, but the present invention is not limited to this, and for example, it is also possible to provide the first conductive film 38 and the second conductive film 39 only and use themselves as electrodes instead of providing the first electrode 40 and the second electrode 41. However, in improving conductivity of electrodes, it is preferable to provide the first electrode 40 and the second electrode 41 as described above.

Also, in the above embodiment, the liquid crystal display device 1 having the touch sensor projection 50 formed on the opposite substrate 11 has been described. However, the present invention is not limited to this, and for example, touch sensor projections may be formed in the TFT substrate 12 or may be formed in both the TFT substrate 12 and the opposite substrate 11.

Additionally, although the above embodiment has exemplified the case where one of the two wires connected to the detection element 42 is commonly used as the source wiring 14 connected to the TFT 16 for display control, other configurations may be adopted. For example, one of the two wires connected to the detection element 42 may be commonly used as the gate wiring 13. Also, two wires connected to the detection element 42 may be formed separately and independently from the source wiring 14 and the gate wiring 13. In this case, two detection lines extending along the source wiring 14 and the gate wiring 13, respectively, are to be formed. In this manner, a touch position can be detected anytime independently from the control of display by the gate wiring 13 and the source wiring 14. Therefore, the detection accuracy can be further enhanced.

Additionally, as for the TFT 16 and the detection element 42, it is possible to use not only TFT but also other switching elements which can switch electric current on and off.

### INDUSTRIAL APPLICABILITY

As described above, the present invention is useful for a liquid crystal display device which detects positional information on a display screen and a method for manufacturing the same.

### DESCRIPTION OF REFERENCE CHARACTERS

1 liquid crystal display device

10 liquid crystal layer

11 opposite substrate (first substrate)

12 TFT substrate (second substrate)

25 glass substrate (first insulating substrate)

27 opposite electrode

31 first alignment film

32 second alignment film

35 glass substrate (second insulating substrate)

38 first conductive film

39 second conductive film

40 first electrode

41 second electrode

42 detection element

49 conductive film

50 touch sensor projection

71 first contact region

72 second contact region

1. A liquid crystal display device comprising:
a first substrate;
a second substrate placed opposite to the first substrate;
a liquid crystal layer disposed between the first substrate and the second substrate; and
alignment films provided and hardened on surfaces on the liquid crystal layer side of the first substrate and the second substrate, respectively,
wherein the liquid crystal display device detects a pressed position by having contact regions, which are a part of the first substrate and a part of the second substrate, in contact with each other when the first substrate or the second substrate is bent by being pressed, and
wherein, in each of the contact regions of the first substrate and the second substrate, a conductive film which repels the alignment film before hardening is arranged, respectively, such that the conductive film is exposed from the hardened alignment film.

2. The liquid crystal display device according to claim 1, further comprising a touch sensor projection projecting toward the second substrate side in the contact region of the first substrate,
wherein the conductive films include a first conductive film provided on the tip side of the touch sensor projection and a second conductive film provided in the contact region of the second substrate.

3. The liquid crystal display device according to claim 2, wherein a first electrode covered with the first conductive film is provided at a tip of the touch sensor projection, and
wherein a second electrode covered with the second conductive film is provided in the contact region of the second substrate.

4. The liquid crystal display device according to claim 3, wherein a detection element which is connected to the second electrode and detects a conduction state between said second electrode and the first electrode is provided in the second substrate.

5. A method of manufacturing a liquid crystal display device that includes a first substrate and a second substrate opposite to each other having a liquid crystal layer therebetween, and alignment films provided and hardened on the respective surfaces on the liquid crystal layer side of said first substrate and said second substrate, and configured so as to detect a pressed position by having contact regions, which are a part of the first substrate and a part of the second substrate, in contact with each other when the first substrate or the second substrate is bent by being pressed, the method comprising:
a first step of forming the first substrate by forming a first conductive film that repels the alignment film before hardening in a region of a first insulating substrate that becomes the contact region of the first substrate, and then applying the alignment film before hardening to the first insulating substrate to expose the first conductive film from said alignment film;
a second step of forming the second substrate by forming a second conductive film that repels the alignment film before hardening in a region of a second insulting substrate that becomes the contact region of the second substrate, and then applying the alignment film before hardening to the second insulating substrate to expose the second conductive film from said alignment film; and
a third step of bonding the first substrate and the second substrate together on the sides where the alignment films are formed.

6. The method of manufacturing a liquid crystal display device according to clam 5, wherein the first step comprises forming a touch sensor projection projecting toward the second substrate side in a region of the first insulating substrate that becomes the contact region of the first substrate and forming the first conductive film on a tip side of the touch sensor projection thereafter.

7. The method of manufacturing a liquid crystal display device according to claim 6, wherein the first step comprises forming a first electrode at a tip of the touch sensor projection, and forming the first conductive film thereafter to cover said first electrode, and
wherein the second step comprises forming a second electrode in a region that becomes the contact region of the second insulating substrate, and forming the second conductive film thereafter so as to cover said second electrode.

8. The method of manufacturing a liquid crystal display device according to claim 7, wherein the second step includes forming a detection element that is connected to the second electrode and that detects a conduction state between said second electrode and the first electrode in the second insulating substrate.

9. The method of manufacturing a liquid crystal display device according to claim 5, wherein the first conductive film and the second conductive film are formed by photolithography in the first step and in the second step, respectively.
